(19) United States
(12) Patent Application Publication
(10) Pub. No.: US 2015/0039506 A1
(43) Pub. Date: Feb. 5, 2015

(54) METHODS AND SYSTEMS FOR PROVIDING 3-D SECURE SERVICE ON-BEHALF-OF MERCHANTS

(71) Applicant: MasterCard International Incorporated, Purchase, NY (US)

(72) Inventors: Peter J. Groarke, Dublin (IE); Mark Wiesman, Chesterfield, MO (US); John Delton Chisholm, Ballwin, MO (US); Theunis Johannes Gerber, Wildwood, MO (US); Ishfaq A. Lone, Dublin (IE); Gregory Williamson, Stamford, CT (US)

(73) Assignee: MasterCard International Incorporated, Purchase, NY (US)

(21) Appl. No.: 13/958,951

(22) Filed: Aug. 5, 2013

(51) Int. Cl. G06Q 20/40

(52) U.S. Cl. CPC G06Q 20/40
USPC 705/44

(57) ABSTRACT

Systems and methods for conducting 3-D Secure transactions on-behalf-of (OBO) merchants. In an embodiment, a payer authentication response (PARes) message indicating enrollment in the 3-D Secure OBO merchants authentication service is received from an access control server by a computer and stored. The computer later receives a purchase transaction authorization request message, determines that data of the purchase transaction authorization request message matches stored PARes message data, and then injects a UCAF into the purchase transaction authorization request message to generate an updated transaction authorization request message. The updated transaction request message is then transmitted to an issuer financial institution for 3-D Secure purchase transaction authorization processing.

### FIELD OF THE INVENTION

Embodiments disclosed herein generally relate to techniques for conducting secure online purchase transactions, and more particularly to techniques for providing 3-D Secure transactions on-behalf-of (OBO) merchants.

### BACKGROUND

Payment cards such as credit or debit cards are ubiquitous, and for decades such cards have included a magnetic stripe on which the relevant account number is stored. Traditionally, to consummate a purchase transaction with such a payment card, the card is swiped through a magnetic stripe reader in a retail store that is part of the point-of-sale (POS) terminal. The reader reads the account number from the magnetic stripe, and that account number is then used to route a transaction authorization request that is initiated by the POS terminal.

Payment card-based transactions are now typically performed across multiple channels of commerce. For example, payment card-based transactions may be performed in-person at a retail outlet, via a computer connected to the internet (an online transaction), via a mobile phone and/or via a company-based call center (e.g., a 1-800 number for a catalog company). These various types of transactions are conducted in different ways, and thus each type of transaction is associated with a different level of fraud risk. In addition, the payment card transactions generally require that the consumer have his or her payment card available to either present to a cashier in a retail environment, or to enter the requested information via a web browser for an internet transaction, and/or to provide requested information over the telephone. Those knowledgeable in the field recognize that the risk of financial fraud is greater for a remote transaction because there is less ability for the merchant to verify the identity and authenticity of the cardholder. The nature of remote transactions therefore increases risk for the merchant and for the payment card network provider, which often results in more cardholder disputes and associated chargebacks than occur after in-person transactions.

With the advent of e-commerce and m-commerce (mobile commerce), consumers are using portable devices, such as smart phones, tablet computers, and/or personal digital assistants (PDAs), to make purchases via merchant websites over the internet. Consequently, various techniques have evolved that allow for payment for goods and/or services ordered online using payment card accounts.

Attempts to provide an additional security layer for online credit and debit card transactions have been proposed, and several different protocols have been adopted by payment card networks. For example, MasterCard International Incorporated provides the MasterCard SecureCode service which includes cardholder authentication solutions that utilize a universal standard called universal cardholder authentication field (UCAF). The SecureCode service is used by member financial institutions (FI's), merchants and MasterCard in collecting and transporting accountholder authentication data generated by issuer and accountholder security solutions. Thus, the UCAF is intended to be security scheme independent and offers standardized fields and messages for use by merchants and MasterCard members. Once collected by a merchant and their acquirer FI, this information is communicated to the issuer FI in the payment authorization request and provides explicit evidence that the transaction was originated by the accountholder or cardholder. The UCAF supports a variety of issuer security and authentication approaches, including the secure payment application (SPA), issuer servers, smart cards and more. This universal payment mechanism simplifies compatibility and interoperability issues, and keeps costs relatively low when new technologies or upgrades are implemented. Other payment networks utilize similar services, which are generally based on the 3-D Secure protocol, and each of these services generally adds an additional online cardholder authentication process to the standard financial authorization process.

FIG. 1 is a block diagram of a typical transaction system 100 to illustrate an example of the SecureCode authentication process, which involves a number of participants and messages in order to authenticate a cardholder. In order to use SecureCode, a consumer must first visit an issuer enrollment website and provide issuer enrollment data to prove identity, and if appropriate answers are provided, the cardholder is considered authenticated and is permitted to establish a private code or SecureCode to be associated with his or her payment card account number. This private code is stored by the issuer for later use during online purchases at participating merchant websites.

Referring again to FIG. 1, a cardholder desiring to purchase goods and/or services over the internet operates a consumer device, such as a computer 102, and uses his or her internet browser to contact 101 a merchant server 106 to shop at a merchant website. The merchant server 106 includes a merchant plug-in (“MPI”) application 108, which will be explained below. After selecting merchandise and/or services, to initiate the purchase, the cardholder provides payment card account information (including a primary account number or “PAN”, an expiration date, a cardholder verification value or “CVC2” value, billing address information, and the like) at the merchant's website checkout webpage. The data is then typically transmitted over a secure socket layer (“SSL”) connection from the cardholder's computer 102 to the merchant's server computer 106. The merchant website server 106 receives the SSL data, and the MPI 108 generates and sends verification request and verification response messages via a SSL connection 103 to a Directory Service server computer 110 (which may be the MasterCard Directory service). The Directory Service server uses a bank identification number (BIN), which is part of the PAN, to check card range eligibility for the SecureCode service and to identify the relevant issuer financial institution (FI). If the specified PAN is in the eligible payment card range, then the data is transmitted via another SSL connection 105 to an issuer access control server (ACS) 112 to check if the specific account number is enrolled and active to participate in the SecureCode service. If the cardholder is enrolled, the ACS 112 establishes a secure session via connection 107 with the merchant server computer 106, and the MPI 108 creates a payer authentication request message which is transmitted back to the ACS 112. When the ACS receives the payer authentication request message, it causes an authentication dialog to begin with the cardholder which causes a separate authentication window to appear in the cardholder's browser. The authentication window, which is typically presented during the shopping checkout process, prompts the cardholder to enter his or her private code or SecureCode. The consumer enters the private code and the cardholder's browser redirects 109 the information to the ACS for authentication. If the private code is correct, then the cardholder is authenticated, an accountholder authentication variable (“AAV”) is returned to the MPI 108 of the merchant server 106, and the cardholder authentication window disappears. The AAV is a SecureCode specific token that uses the UCAF field for transport within the authorization messages. Thus, at this point in the process, the merchant server 106 transmits 111 the AAV to a gateway/acquirer system 114 as part of a purchase authorization request. Next, the gateway/acquirer system submits 113 the purchase authorization request to a payment network 116, which forwards 115 the authorization request message to an issuer server computer 118 for conventional purchase transaction authorization processing.

The 3-D Secure authentication process thus provides a greater level of authentication during transactions which reduces “unauthorized transaction” chargebacks for merchants. However, as illustrated above with regard to FIG. 1, such 3-D Secure processes can be unwieldy and involve a large number of messages and participants. In addition, the cardholder must authenticate every time he or she makes an online purchase, which can be onerous and detract from the overall consumer shopping experience. In addition, in order to use such 3-D secure systems, the Merchant and/or Acquirer financial institution must purchase, install, implement and/or maintain MPI application software which was developed and tested to be compliant with the 3-D Secure protocol messages, and that is configured to modify the subsequent authorization to include a UCAF to connect to the Directory Server. In some cases, the plug-in application is provided by a technology vendor and integrated into the merchant's e-commerce server, which can be expensive for the merchant due to setup fees, monthly fees and/or per-transaction fees that may be charged. In addition, supporting a 3-D secure system can be complicated, and may create transaction failures. Also, the large number of messages passing across the network lead to a substantial volume of network traffic and cause delay in carrying out transactions due to the latency of the systems in dealing with the messages.

In order to avoid or minimize consumer dissatisfaction, modified and/or pseudo implementations of the security protocol have been developed. For example, the MasterCard Advance Registration Program (MARP) was developed to permit qualifying merchants (who authenticate shoppers and have robust anti-fraud solutions already in place and a low number of chargebacks) to send a merchant-specific and/or card scheme assigned static accountholder authentication value (static AAV) instead of a UCAF with the payment card authorization message. In such cases, the card issuer validates the static AAV instead of the usual UCAF. To be eligible for MARP, the merchant must enable its customers to register on the merchant's website by selecting a username and password (or similar credentials), and provide cardholders with the option to register a MasterCard card account number for use in future e-commerce transactions. The merchant will also be expected to satisfy minimum security requirements intended to help ensure the protection of all participants: the merchant, its acquirer, the issuer, and the cardholder. The merchant is required to offer customers a safe, secure shopping experience by using best practice risk management tools, and must demonstrate a commitment to conducting business in a manner that does not result in excessive chargebacks. However, even when enrolled to use MARP, the merchant and/or acquirer must modify their card authorization processes to inject the static AAV (pseudo-UCAF) which necessitates time, effort and expenditure.

The disadvantages highlighted above have hampered the uptake of the various 3-D Secure protocols and the various types of modified or pseudo 3-D security protocols. Therefore, the inventors recognized that it would be desirable to provide a less complicated, secure online authentication process that reduces fraud and risk, and that is less technically complex and easier for merchants to implement and maintain.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate exemplary embodiments and which are not necessarily drawn to scale, wherein:

FIG. 1 is a block diagram of a transaction system to illustrate a conventional 3-D Secure authentication process;

FIG. 2 is a block diagram of an authentication system to illustrate a 3-D Secure on-behalf of (OBO) merchants process according to an embodiment of the invention;

FIG. 3 is a block diagram of an embodiment of a merchant OBO service computer according to an embodiment of the invention;

FIG. 4 is a flowchart of a merchant OBO service process in accordance with some embodiments of the invention;

FIG. 5 is a block diagram of an embodiment of a payment network computer according to an embodiment of the invention;

FIG. 6 is a flowchart of a merchant OBO service process in accordance with some embodiments of the invention;

FIG. 7 is a block diagram of another embodiment of a purchase transaction system illustrating an example of a 3-D Secure on-behalf-of (“OBO”) merchants authentication process in accordance with the invention;

FIG. 8 is a block diagram of an embodiment of a payment card processor system computer according to an embodiment of the invention; and

FIG. 9 is a flowchart of a payment card processor system computer process in accordance with some embodiments of the invention.

### DETAILED DESCRIPTION

Reference will now be made in detail to various embodiments of the invention. Examples of these embodiments are illustrated in the accompanying drawings, and it should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

Embodiments relate to payment card account authentication processes, and more particularly, to online or remote payment card authentication processes. For example, a remote authentication process may include a process where a consumer is making a purchase or other transaction with a remote website or merchant server (e.g., over the Internet) using a browser on a mobile device (such as a mobile telephone, smartphone, tablet computer, and/or laptop computer and the like). A remote authentication process may also include a process where a consumer is making a purchase or other transaction with a remote website or server using a browser on a personal computer or any other type of Internet-connected device (such as a television, household appliance, office device, or the like). Thus, embodiments of the authentication process described herein pertain to card not present (CNP) transactions wherein a novel on-behalf-of (OBO) merchant service process operates to carry out a universal cardholder authentication field (UCAF) or a MasterCard advance registration program (MARP) (i.e., a 3-D Secure-type process) injection into a cardholder's purchase transaction authorization request en-route to the issuer financial institution (FI), which operation would otherwise be carried out by the merchant and/or by the acquirer FI. Thus, the result of such a 3-D Secure OBO merchant process is indistinguishable from that of a conventional 3-D Secure process to issuer FIs and to cardholders.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, individual, business or other entity that has been issued (or authorized to use) a financial account such as a credit or debit account. The financial account may be accessed by use of a “payment card” or “payment device” such as a traditional plastic or embossed magnetic stripe card, a chip card (such as an EMV card) or a radio-frequency identification (RFID) card (such as a PayPass™ card) or other type of contactless payment card. Pursuant to some embodiments, as used herein, the term “payment card” or “payment device” may also include a mobile device (such as a mobile telephone, a smartphone, a tablet computer, and/or a personal digital assistant) operating a payment application that includes stored payment account information.

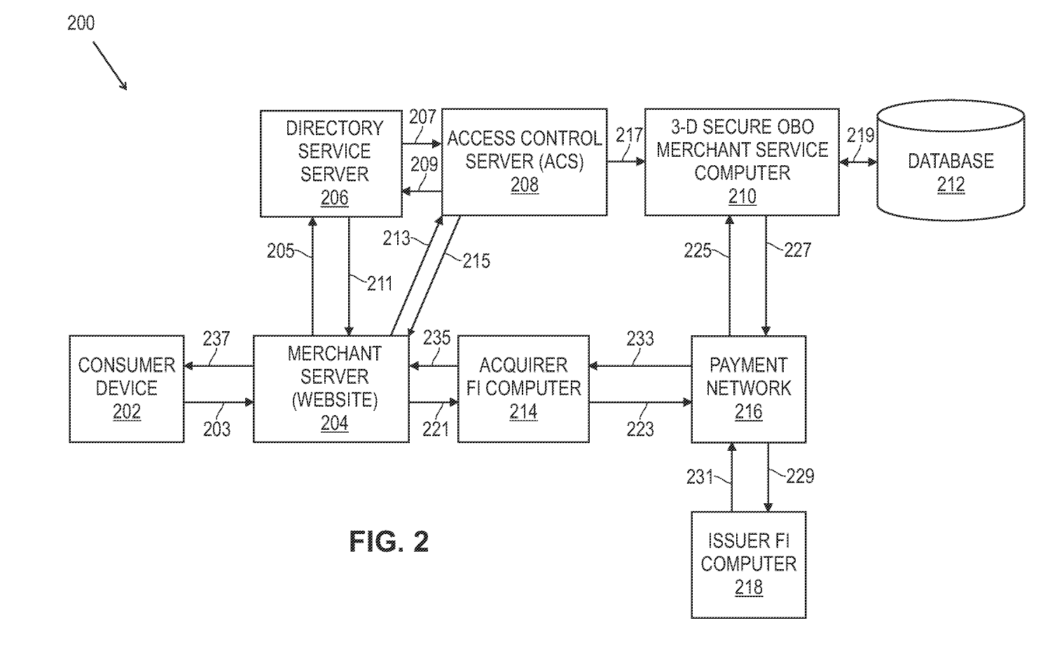

FIG. 2 is a block diagram of a transaction system 200 to illustrate an example of a 3-D Secure on-behalf-of (“OBO”) merchants authentication process in accordance with some embodiments. In a particular example, a merchant such as “BigBox Store” may decide that all consumers who purchase goods and/or services online with payment card accounts, including BigBox Store payment card accounts (which may be credit card accounts or debit card accounts sponsored by a payment card processing company, such as MasterCard International Incorporated) will have their purchases processed in accordance with the 3-D Secure OBO merchants authentication service. BigBox Store therefore may enroll in the 3-D Secure on-behalf-of (“OBO”) merchants authentication service by providing required merchant identification information (such as a BigBox merchant ID) to the entity providing the 3-D Secure OBO merchants authentication service (which may be, for example, a payments processing company such as MasterCard International Incorporated). Similarly, a merchant acquirer FI, which has financial accounts associated with clients such as the BigBox Store, may also enroll some or all of their clients in the 3-D Secure OBO merchants service as a benefit to those clients. For example, a particular acquirer FI may enroll one or more clients (merchants) by providing an acquirer identifier (acquirer ID) to the entity providing the 3-D Secure OBO merchants authentication service along with one or more merchant identifiers. In this example, if the BigBox Store is a client, then all online purchase transactions originating from the BigBox Store website would be eligible for 3-D Secure on-behalf-of (“OBO”) merchants authentication processing. However, in accordance with some implementations, the cardholders (consumers) and their issuer FIs (the financial institutions that issued the consumers' payment card accounts) may be unaware of the 3-D Secure OBO merchant service processing which has occurred or is occurring during online purchase transactions from the BigBox Store website. In some embodiments, the entity providing the 3-D Secure OBO merchants authentication service (such as an online payments processing service company) may charge a fee or fees to merchants and/or to acquirer FIs for providing the service. However, in some implementations, the entity responsible for providing the 3-D Secure OBO merchants service (for example, a cardholder payments processing company such as MasterCard International Incorporated) may not charge a fee or impose only a nominal fee for the service as an incentive to increase adoption of their payment network and/or to increase use of their 3-D Secure OBO merchants payment service.

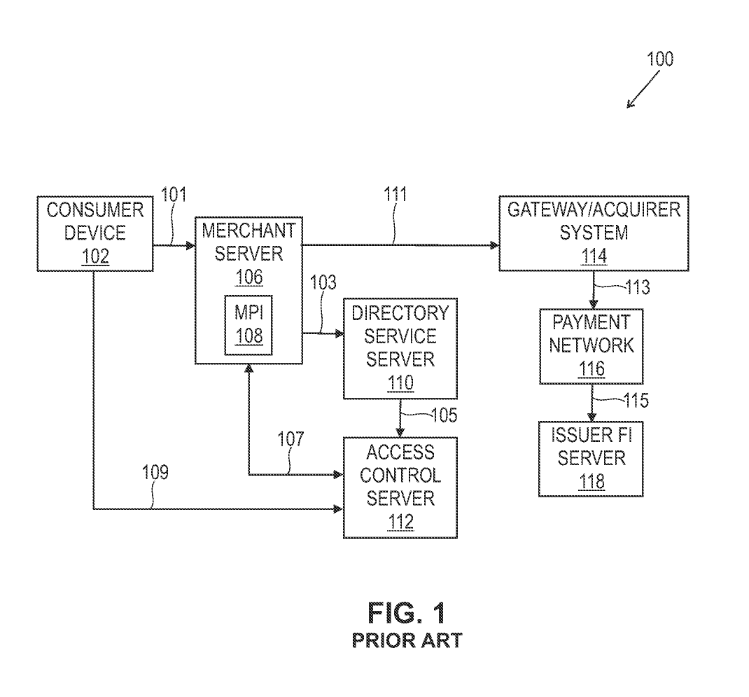

Referring again to FIG. 2, a cardholder desiring to purchase goods and/or services over the internet operates his or her consumer device 202 (which may be a mobile device, tablet computer, desktop computer or the like), and uses an internet browser to communicate via connection 203 with a merchant server 204 to shop at the merchant's website. The purchase transaction system 200 also includes a directory service server computer 206, an access control server computer 208, a 3-D Secure on-behalf-of (OBO) merchant service computer 210, a database 212, an acquirer FI computer 214, a payment network 216 and an issuer FI computer 218. It should be understood, however, that the purchase transaction system 200 may include a plurality of merchant server computers, directory service server computers, access control server computers, 3-D Secure OBO merchant service computers, acquirer FI computers and issuer FI computers, but only one of each of these devices are shown in FIG. 2 for ease of understanding. It should also be noted that, unlike the merchant server 106 of the system 100 of FIG. 1, the merchant server 204 does not include a merchant plug-in (“MPI”) application because it is not necessary. In addition, it should be understood that the various computers and/or computer systems shown in FIG. 2 may be configured to communicate directly with one another via, for example, secure connections, or may be configured to communicate via the Internet and/or via other types of computer networks and/or communication systems in a wired or wireless manner.

A cardholder uses his or her consumer device 202 to browse the offerings on the merchant's website, selects merchandise and/or services and then initiates a purchase transaction by providing payment card account information at the merchant's website checkout webpage (not shown) hosted by the merchant server 204. The payment account information typically includes a primary account number or “PAN”, an expiration date, a cardholder verification value or “CVC2” value, cardholder address information, and the like. (In the case of a repeat customer, the merchant website may already have much if not all of the consumer's payment account data saved in a secure storage element and thus the merchant's checkout webpage may be configured to automatically populate most, if not all, of the required payment account data.) The merchant website server 204 then transmits 205 a verify enrollment request (“VEReq”) message to a Directory Service server computer 206 (for example, a service directory computer operated by a payment card system provider, such as MasterCard International Incorporated). The Directory Service computer 206 provides centralized decision-making capabilities to merchants and uses the account number in the VEReq message to direct that VEReq to an appropriate issuer Access Control Server (ACS) 208. Upon receipt of the VEReq, the ACS 208 verifies whether the cardholder's payment card account is enrolled in a 3-D Secure service (for example, the merchant ID may indicate enrollment in the 3-D Secure OBO merchants service) and if so the ACS 208 transmits 209 a positive verify enrollment response (“VERes”) message to the Directory Service server computer 206, which message includes the address of the ACS 208. The Directory Service server computer 206 then forwards 211 the positive VERes with the ACS address to the merchant server computer 204. The merchant server then generates a payer authentication request (“PAReq”) message to authenticate the consumer (payer) for that particular online purchase and transmits 213 the PAReq message directly to the ACS 208 (by using the ACS address) for cardholder authentication.

If the ACS 208 successfully authenticates the cardholder, the ACS then generates a positive payer authentication response (“PARes”) message which includes a UCAF. The positive PARes message is transmitted 215 to the merchant server 204. In addition, the ACS transmits 217 the PARes message to the 3-D Secure OBO merchant service computer 210 in case that particular merchant is enrolled in the 3-D Secure OBO merchants authentication service. In some embodiments, the positive PARes message includes fields containing the cardholder's PAN, an acquirer identifier, a merchant identifier, the date and/or time of the transaction, the transaction amount, a transaction currency code, and the UCAF. In addition, in some implementations a transaction identifier (“XID”) is included in the PARes message.

In some embodiments, the 3-D Secure OBO merchant service computer 210 is operated by a service provider (which may be a third party provider), whereas in other implementations the 3-D Secure OBO merchant service computer 210 is operated by a payment card account processing company (such as MasterCard International Incorporated). Upon receiving the PARes message from the ACS, in some embodiments the 3-D Secure OBO merchant service computer stores 219 the PARes message (which includes the UCAF and the other transaction data) in a database 212, which may be a separate secure storage device. (In some embodiments, the 3-D Secure OBO merchant service computer may store the PARes message in a secure element or secure portion of an internal memory.)

When the merchant server 204 receives 215 the positive PARes message, it generates and then transmits 221 a purchase transaction authorization request to an acquirer FI computer 214. (In some embodiments, the merchant server 204 simply ignores the UCAF that is present in the PARes message when generating the purchase transaction authorization request.) The acquirer FI computer then forwards 223 the purchase transaction authorization request to a payment network 216 (which includes one or more computers and/or computer systems). The payment network 216 receives the purchase transaction authorization request, and utilizing the merchant ID and/or the acquirer ID, recognizes that the purchase transaction authorization request may be eligible for 3-D Secure OBO merchants authentication service processing. In such cases, the payment system network 216 transmits 225 the purchase transaction authorization request to the 3-D Secure OBO merchant service computer 210. The 3-D Secure OBO merchant service computer then compares data in the purchase transaction authorization request (which includes the PARes data) with the information stored in the secure database 212 (PARes data) to determine if 3-D Secure OBO merchants processing occurred.

If there is a match, then in some embodiments, the 3-D Secure OBO merchant service computer next compares the time and date of the online or remote purchase transaction (which was stored with the PARes data in the database 212) with the time and date of receipt of the purchase transaction authorization request. If the result falls within a predetermined period of time (or time range) then the 3-D Secure OBO merchant service computer conducts further processing. In some embodiments, the predetermined time period between the time and date data of the stored PARes message data and the received purchase transaction authorization request message must be equal to or less than the time period that an issuer FI would use when deciding if the authorization request message was timely received. In some embodiments, this time period may be on the order of 1 second to 120 seconds (two minutes) because speedy web service calls are not guaranteed. For example, there may be one or more slow connections or broken connections, and/or a contingency may arise that delays a web service call.

Therefore, in some embodiments, if a match occurs between the PARes information stored in the database 212 and the data contained in the purchase transaction authorization request (and if the time period explained above falls within the predetermined time period) then the 3-D Secure OBO merchant service computer 210 injects the UCAF (which was stored when the PARes data was stored in database 212) into the purchase transaction authorization request to create an updated purchase transaction authorization request. The 3-D Secure OBO merchant service computer 210 then transmits 227 the updated purchase transaction authorization request to the payment network 216. The payment network 216 then forwards 229 that updated purchase transaction authorization request to the issuer FI computer 218 for authorization processing as a 3-D Secure transaction. In this case, the issuer FI 218 recognizes that the cardholder has been authenticated using a 3-D Secure authorization protocol, and proceeds to process the updated purchase transaction authorization request accordingly. The issuer FI therefore determines whether or not the consumer's payment card account is in good standing and/or whether the cardholder can or cannot afford to pay for the purchase transaction (for example, if the cardholder has an adequate credit line available to cover the purchase price for the transaction). If all is in order, the issuer FI transmits 231 a positive purchase transaction authorization or “transaction approved” response to the payment network 216 which is then routed or transmitted 233 through to the acquirer FI 214. In some implementations, the acquirer FI transmits 235 the transaction approved message to the merchant server 204, which transmits 237 a message to the consumer device 202. In some cases, the transaction approved message may appear, for example, on a display screen of the consumer's device and may be worded: “Thank you for your purchase.” Thus, the described 3-D Secure OBO merchants authentication process is agnostic with regard to issuer FIs. In addition, the 3-D Secure OBO merchants service benefits merchants and/or acquirer FIs because, after a cardholder is authenticated and the purchase transaction is authorized, liability for that purchase transaction shifts to the issuer FI regarding any fraud charges and any related chargebacks that may occur.

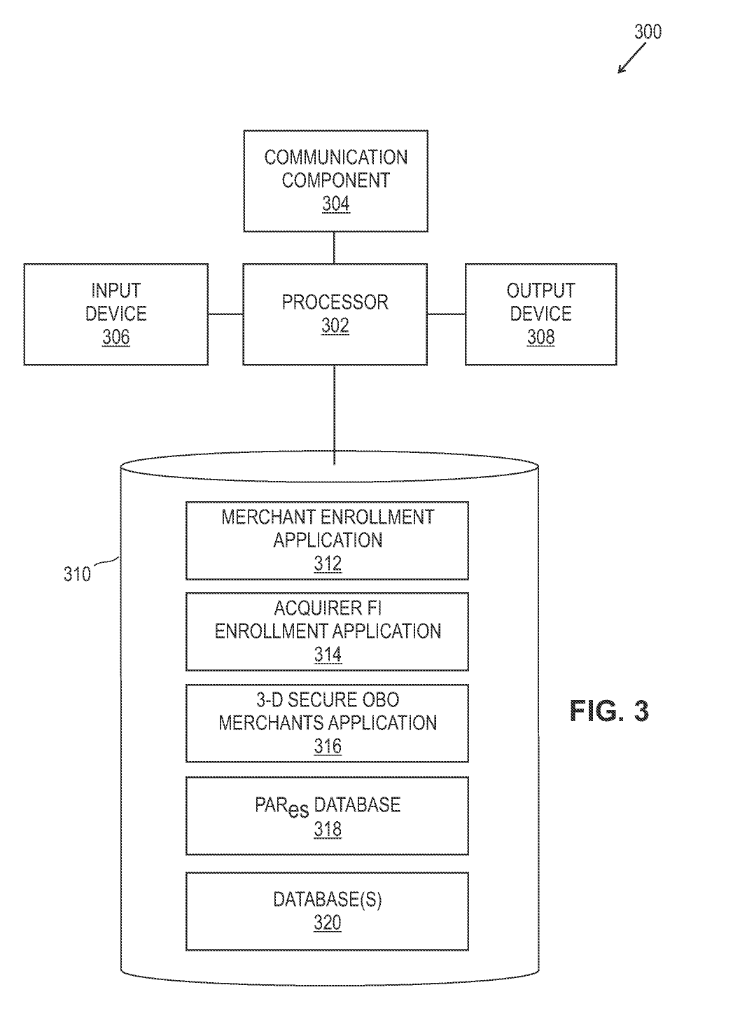

FIG. 3 is a block diagram of an embodiment of a 3-D Secure OBO merchant service computer 300 according to an embodiment. The 3-D Secure OBO merchant service computer may be conventional in its hardware aspects but may be controlled by software to cause it to operate in accordance with aspects of the methods presented herein. In particular, the 3-D Secure OBO merchant service computer 300 may include a computer processor 302 operatively coupled to a communication component 304, an input device 306, an output device 308, and a storage device 310.

The computer processor 302 may constitute one or more conventional processors. Processor 302 operates to execute processor-executable steps, contained in program instructions described herein, so as to control the merchant OBO service computer 300 to provide desired functionality.

Communication component 304 may be used to facilitate communication with, for example, other devices such as other computers (such as for receiving data from an access control server (ACS) computer over the internet). The communication component 304 may also, for example, have capabilities for engaging in data communications over conventional computer-to-computer data networks, and such data communications may be in digital form and/or in analog form.

Input device 306 may comprise one or more of any type of peripheral device typically used to input data into a computer. For example, the input device 306 may include a keyboard and a mouse and/or a touchpad or touchscreen that may be used, for example, by a systems engineer or other personnel authorized to, for example, perform 3-D Secure OBO merchant service computer maintenance, upgrades or other tasks. The output device 308 may comprise, for example, a display and/or a printer or any other peripheral output device.

Storage device 310 may comprise any appropriate information storage device, including combinations of magnetic storage devices (e.g., magnetic tape and/or hard disk drives), optical storage devices such as CDs and/or DVDs, and/or semiconductor memory devices such as Random Access Memory (RAM) devices and Read Only Memory (ROM) devices, solid state drive (SSD) devices, and/or flash memory devices. Any one or more of the listed storage devices may be referred to as a “memory”, “storage”, a “storage medium”, or a “computer readable medium”. In addition, the storage devices are configurable and/or capable of storing instructions, code and/or data, including instructions configured to cause the processor 302 to execute one or more of the processes described herein. Thus, the storage device 310 stores one or more programs for controlling the processor 302, and the programs comprise program instructions that contain processor-executable process steps of the 3-D Secure OBO merchant service computer 300, including, in some cases, process steps that constitute processes provided in accordance with principles of the processes presented herein.

The programs may include a merchant enrollment application 312 that manages processes by which a merchant registers or enrolls for the 3-D Secure OBO merchants authentication service with the 3-D Secure OBO merchant service computer 300. In some embodiments, the merchant OBO service enrollment process allows a merchant to register by providing a merchant identifier (merchant ID), merchant name and address, and/or other required merchant data, for example, by utilizing a suitable web page hosted by the 3-D Secure OBO merchant service computer 300. An acquirer FI registration application 314 may also be stored in the storage device 310, which permits merchant acquirer FIs to register or enroll one or more of their merchant clients by accessing a merchant OBO service web page and providing required information, such an acquirer FI ID, other required acquirer data, and/or one or more merchant IDs.

The storage device 310 also stores a 3-D Secure OBO merchants application 316 for controlling the 3-D Secure OBO merchant service computer 300 to provide merchant OBO processing that includes, in accordance with the disclosure herein, generating an updated purchase transaction authorization request message by injecting a UCAF into a purchase transaction authorization request message received from a payment network. The 3-D Secure OBO merchants application is also configured to control the processor of the 3-D Secure OBO merchant service computer to transmit such an updated purchase transaction authorization request message to, for example, a payment network. In addition, the storage device 310 may include a PARes database 318, and one or more additional databases 320 that are maintained by the 3-D Secure OBO merchant service computer 300 on the storage device 310. Among these databases may be, for example, a merchant ID database and an acquirer FI ID database.

The application programs of the 3-D Secure OBO merchant service computer 300, as described above, may be combined in some embodiments, as convenient, into one, two or more application programs. Moreover, the storage device 310 may store other programs or applications, such as one or more operating systems, device drivers, database management software, web hosting software, and the like.

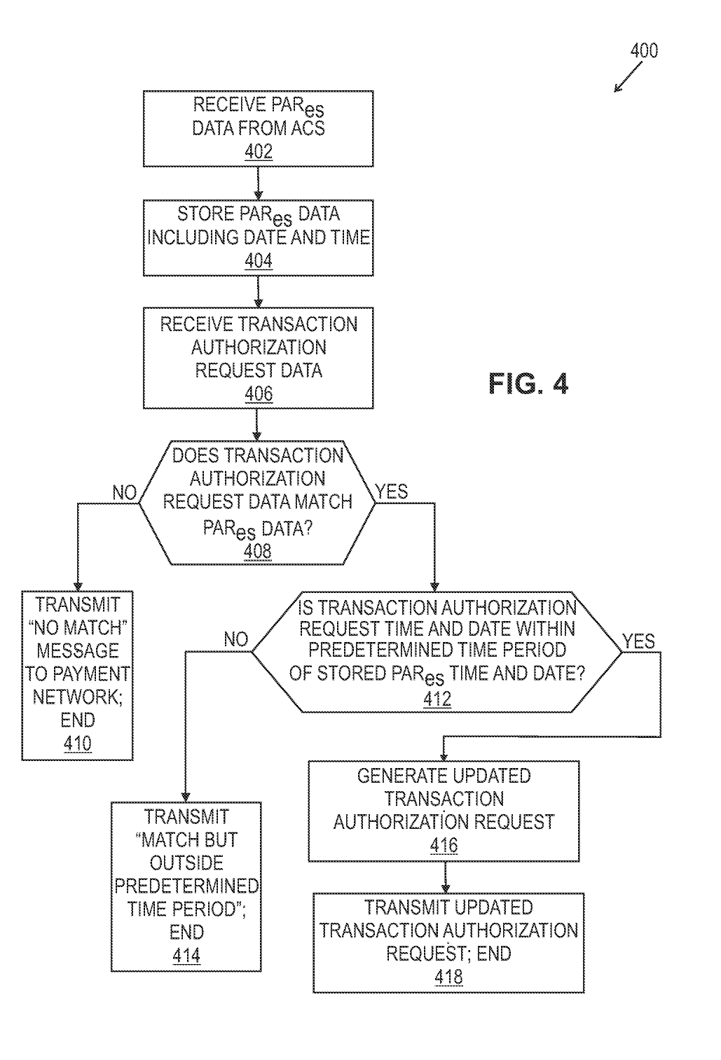

FIG. 4 is a flowchart 400 of a 3-D Secure OBO merchant service process in accordance with some embodiments. The 3-D Secure OBO merchant service computer receives 402 a payer authentication request (PAReq) message and stores 404 the PAReq message data which includes the date and time of the online or remote purchase transaction. Next, the 3-D Secure OBO merchant service computer receives 406 a purchase transaction authorization request message, and compares the data contained in that request message to the stored PAReq data. If there is no match in step 408, then the 3-D Secure OBO merchant service computer transmits 410 a “no match” message to the payment network computer system for business-as-usual processing of the original payment authorization request, and the process ends. In this case, the payment network computer would then transmit the purchase transaction authorization request message to an issuer FI computer as a card not present (CNP) transaction that has not undergone 3-D Secure processing.

However, if in step 408 a match occurs between the purchase transaction authorization request message data and stored PAReq message data, then the 3-D Secure OBO merchants service computer determines 412 whether or not the time and date of receipt of the purchase transaction authorization request message is within a predetermined time period of the stored time and date of the PAReq data. If the purchase transaction authorization request message was not received within the predetermined time period, then the 3-D Secure OBO merchant service computer transmits 414 a “Match but outside predetermined time period” message to the payment network, and the process ends. In some embodiments, when the payment network receives this message then the original transaction authorization request is simply forwarded by the payment network to the Issuer FI as a CNP transaction that has not undergone 3-D Secure processing.

But if in step 412, it is determined that the purchase transaction authorization request message data was received within the predetermined time period (as compared to the date and time of the stored PAReq message data), then the 3-D Secure OBO merchant service computer generates 416 an updated purchase transaction authorization message by injecting the UCAF (found in the stored PARes data) and transmits 418 the updated purchase transaction authorization message to the payment network, and then the process ends. In this case, the payment network forwards the updated purchase transaction authorization request to the issuer FI for authorization processing and the issuer FI recognizes that the cardholder has been authenticated using a 3-D authorization protocol. Thus, the issuer FI then proceeds to process the updated purchase transaction authorization request. If the purchase transaction is ultimately authorized by the issuer FI, liability for that purchase transaction shifts to the issuer FI regarding any fraud charges and any related chargebacks that may occur, which is beneficial for the merchant and for the acquirer FI.

Referring again to FIG. 4, in step 408, in some implementations the 3-D Secure OBO service computer does not transmit a “no match” message when no match is found, but instead the 3-D Secure OBO service computer simply ends processing. In such an implementation, if the payment network does not receive an updated transaction authorization request message from the 3-D Secure OBO merchant service computer within a predetermined time (typically on the order of 500 milliseconds, or some other time period that is considerably less than the time permitted for an authorization to occur, which is typically on the order of 2 or 3 seconds) then the payment network computer simply times-out the OBO service process and continues with 0100 authorization as a regular, non-3-D Secure purchase transaction. That is, the original purchase transaction authorization request is processed in a non-3-D Secure manner. In some embodiments, the same type of processing can occur in step 412 when the time and date of the transaction authorization request is not within the predetermined range of the stored PARes time and date.

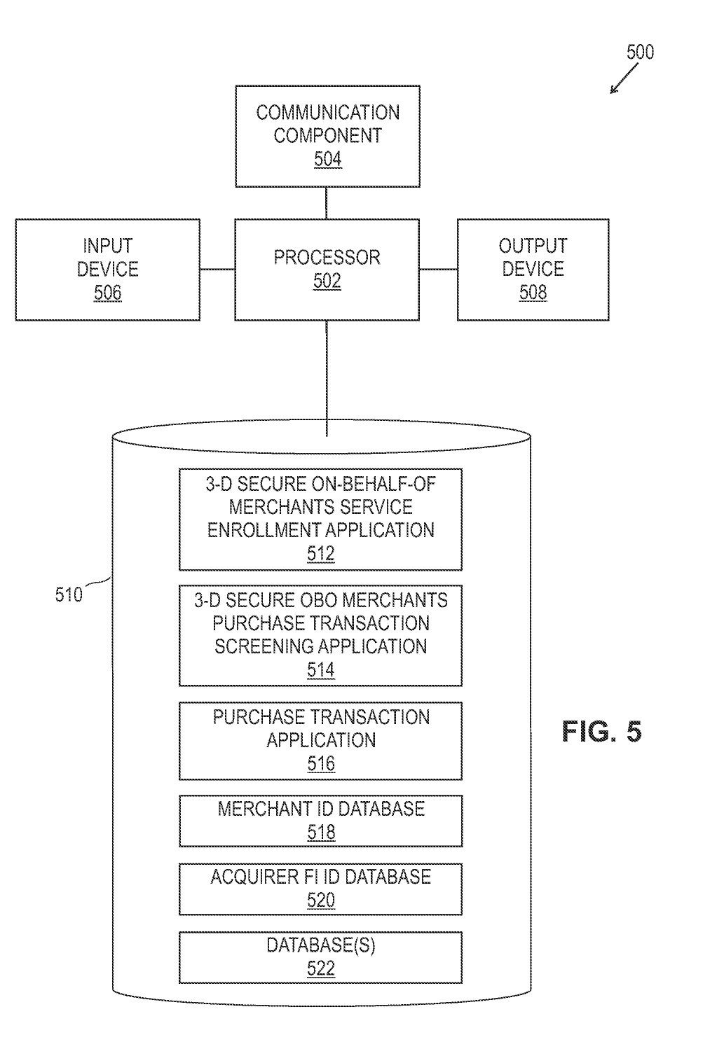

FIG. 5 is a block diagram of an embodiment of a payment network computer 500 according to an embodiment. The payment network computer 500 may be conventional in its hardware aspects but may be controlled by software to cause it to operate in accordance with aspects of the methods presented herein. In particular, the payment network computer 500 may include a computer processor 502 operatively coupled to a communication component 504, an input device 506, an output device 508, and a storage device 510.

The computer processor 502 may constitute one or more conventional processors. Processor 502 operates to execute processor-executable steps, contained in program instructions described herein, so as to control the payment network computer 500 to provide desired functionality.

Communication component 504 may be used to facilitate communication with, for example, other devices such as other computers (such as for communicating with acquirer FI computers, issuer FI computers, and the merchant OBO service computer over the internet). The communication component 504 may also, for example, have capabilities for engaging in data communications over conventional computer-to-computer data networks, and such data communications may be in digital form and/or in analog form.

Input device 506 may comprise one or more of any type of peripheral device typically used to input data into a computer. For example, the input device 506 may include a keyboard and a mouse and/or a touchpad or touchscreen that may be used, for example, by a systems engineer or other personnel authorized to, for example, perform payment network computer maintenance, upgrades or other tasks. The output device 508 may comprise, for example, a display and/or a printer or any other peripheral output device.

Storage device 510 may comprise any appropriate information storage device, including combinations of magnetic storage devices (e.g., magnetic tape and/or hard disk drives), optical storage devices such as CDs and/or DVDs, and/or semiconductor memory devices such as Random Access Memory (RAM) devices and Read Only Memory (ROM) devices, solid state drive (SSD) devices, and/or flash memory devices. Any one or more of the listed storage devices may be referred to as a “memory”, “storage”, a “storage medium”, or a “computer readable medium”. In addition, the storage devices are configurable and/or capable of storing instructions, code and/or data, including instructions configured to cause the processor 502 to execute one or more of the processes described herein. Thus, the storage device 510 stores one or more programs for controlling the processor 502, and the programs comprise program instructions that contain processor-executable process steps of the payment network computer 500, including, in some cases, process steps that constitute processes provided in accordance with principles of the processes presented herein.

The programs may include a 3-D Secure OBO merchants service enrollment application 512 that manages processes by which merchants and/or acquirer FIs register or enroll for the 3-D Secure OBO merchants service. In some embodiments, merchants and/or acquirer FIs enroll by providing merchant ID's, acquirer FI ID's, and/or other merchant and acquirer FI information, for example, by utilizing a suitable web page hosted by the payment network computer 500. The information gathered from a merchant may include the merchant's name and address, a merchant ID, and other required data, whereas the information obtained from an acquirer FI may include an acquirer ID and/or one or more merchant IDs and other required data.

The storage device 510 also stores a 3-D Secure OBO merchant service purchase transaction screening application 514 that includes computer executable instructions for causing the processor to screen received purchase transaction authorization requests for an indication that a particular purchase transaction may have underwent 3-D Secure OBO merchants service processing. In some embodiments, a merchant ID and/or an acquirer FI ID contained within a received purchase transaction authorization request is compared to stored merchant IDs and/or to stored acquirer FI IDs. If there is a match, then the payment network computer 500 handles that particular purchase transaction authorization as explained herein, by comparing the data of the purchase transaction authorization request to stored PARes data and then proceeding accordingly with 3-D Secure OBO merchant service processing if there is a match, generating an updated purchase transaction authorization request when appropriate, and using the updated purchase transaction authorization request for further processing.

Referring again to FIG. 5, the storage device may also store a purchase transaction application 516 for handling updated purchase transaction requests (which include a UCAF) and to handle purchase transaction requests that have not been updated. In addition, the storage device 510 may include a merchant ID database 518, an acquirer FI ID database 520, and one or more additional databases 522 that are maintained by the payment network computer 500 on the storage device 510.

The application programs of the payment network computer 500, as described above, may be combined in some embodiments, as convenient, into one, two or more application programs. Moreover, the storage device 510 may store other programs or applications, such as one or more operating systems, device drivers, database management software, web hosting software, and the like.

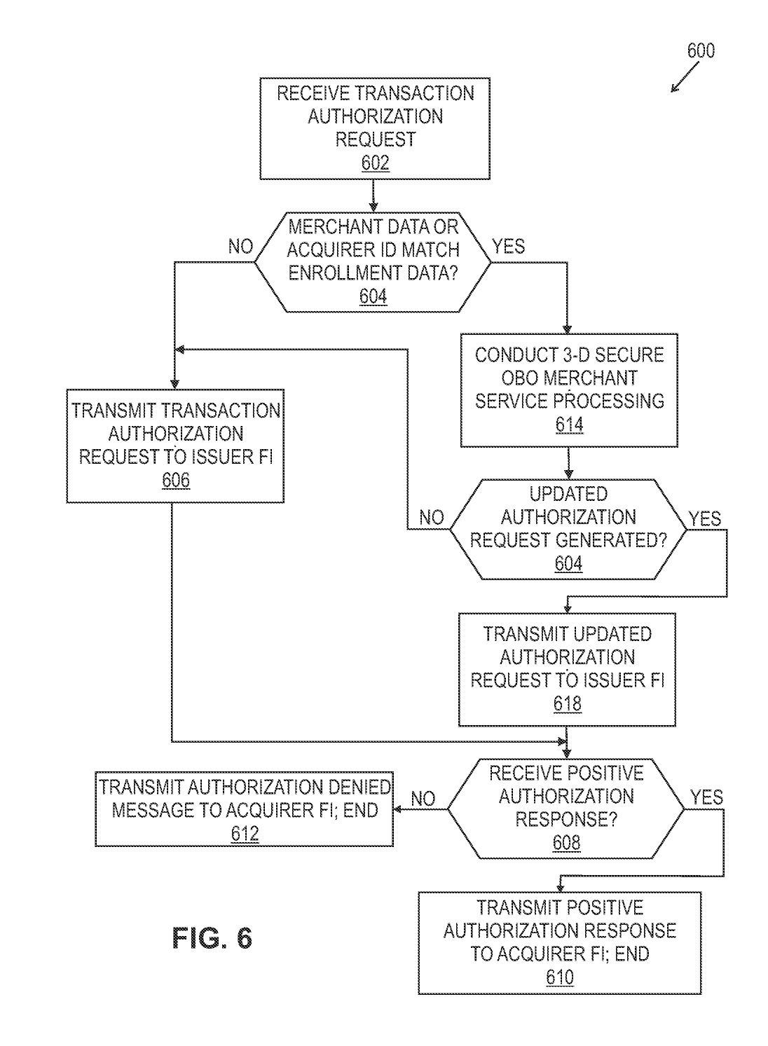

FIG. 6 is a flowchart 600 of a 3-D Secure OBO merchants application process conducted by a payment network computer in accordance with some embodiments. The payment network computer receives 602 a purchase transaction authorization request from an acquirer FI and compares 604 merchant identification data and/or acquirer identification data of that authorization request to enrollment data stored in a memory. If there is no match, then the purchase transaction authorization request message is transmitted 606 to an issuer FI that is identified by data in the authorization request for authorization processing, which is business as usual processing. Thus, if a positive authorization response is received 608 from the issuer FI, then a positive authorization response message is transmitted 610 to the acquirer FI and the process ends. But if a positive authorization response is not received (or a negative response is received) from the issuer FI, then the payment network computer transmits 612 an authorization denied message to the acquirer FI and the process ends.

However, if the merchant identification data and/or acquirer identification data of the transaction authorization request matches 604 stored enrollment data, then the payment network computer conducts 614 3-D Secure OBO merchant service processing, which may include injecting a stored UCAF into the original payment authorization request message to form an updated authorization request message. If an updated authorization request is generated 616, then the payment network computer transmits 618 the updated authorization request to the issuer FI identified by the data in the purchase transaction authorization request for authorization processing. If a positive authorization response is received 608 from the issuer FI, then a positive authorization response message is transmitted 610 to the acquirer FI and the process ends. But if a positive authorization response is not received (or a negative response is received) from the issuer FI, then the payment network computer transmits 612 an authorization denied message to the acquirer FI and the process ends.

Referring again to step 616, if an updated purchase transaction authorization request is not received, then the payment network computer transmits 606 the original (not updated) purchase transaction authorization request message to an issuer FI identified by data in the authorization request for authorization processing, which is business as usual processing. As explained above, if a positive authorization response is received 608 from the issuer FI, then a positive authorization response message is transmitted 610 to the acquirer FI and the process ends. But if a positive authorization response is not received (or a negative response is received) from the issuer FI, then the payment network computer transmits 612 an authorization denied message to the acquirer FI and the process ends.

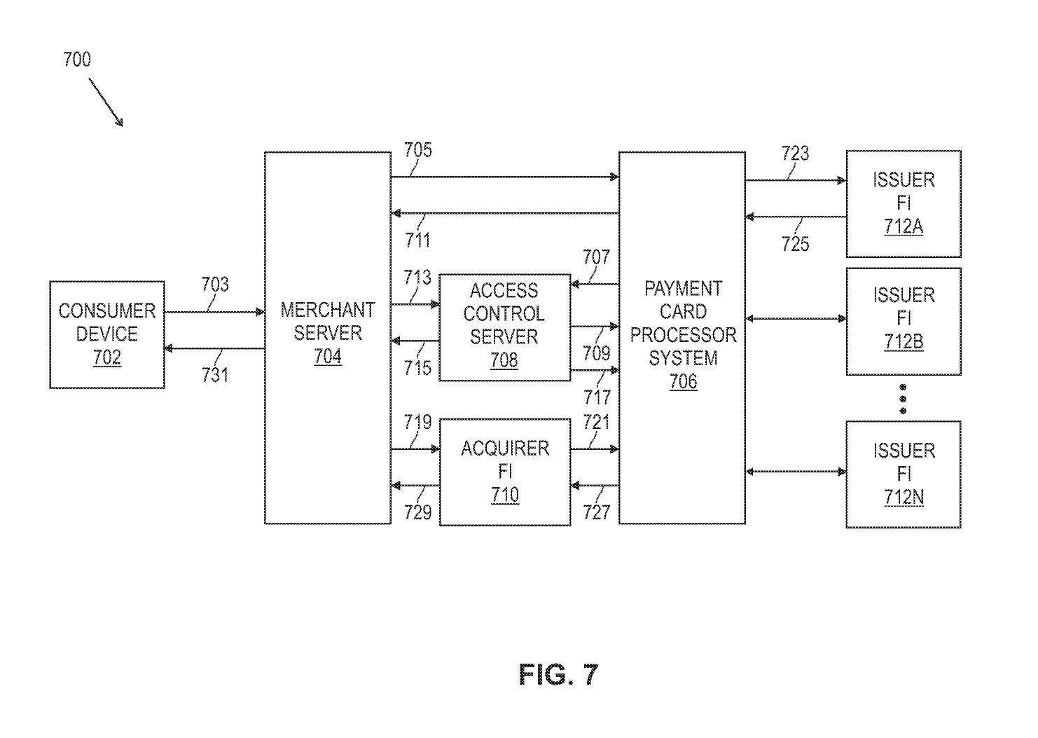

FIG. 7 is a block diagram of another purchase transaction system 700 in accordance with an embodiment, for conducting a 3-D Secure on-behalf-of (“OBO”) merchants authentication process. As explained above, merchants and/or acquirer financial institutions (FIs) enroll for the 3-D Secure OBO merchants authentication service. For example, a merchant may decide to participate in the 3-D Secure OBO merchants service and then registers or enrolls by providing a merchant ID, merchant name and address and other required merchant data, for example, by utilizing a webpage provided by the payment card processor system 706. Acquirer FIs, which have financial accounts associated with merchant clients, may also enroll one or more of their clients in the 3-D Secure OBO merchants service as a benefit to those clients. In this case, a particular acquirer FI may enroll one or more clients by providing an acquirer FI ID, merchant IDs, and/or other relevant data. The company providing the payment card account processing computer 706 offering the 3-D Secure OBO merchants authentication service may charge a fee or fees to merchants and/or to acquirer FIs for providing the service, as explained above.

Referring again to FIG. 7, a cardholder desiring to purchase goods and/or services over the internet operates his or her consumer device 702 (which may be a mobile device, tablet computer, desktop computer or the like), and uses an internet browser to communicate via connection 703 with a merchant server 704 to shop at the merchant's website. The purchase transaction system 700 also includes a payment card processor system 706, an access control server computer 708, an acquirer FI computer 710, and a plurality of issuer FI computers 712A, 712B to 712N. For ease of understanding, only one merchant server computer 704, one access control server computer 708, and one acquirer FI computer 710 are shown, but many more such computers may be part of the overall purchase transaction system 700. In addition, it should be understood that the various computers and/or computer systems shown in FIG. 7 may be configured to communicate directly with one another via, for example, secure connections, or may be configured to communicate via the Internet and/or other types of computer networks and/or communication systems in a wired or wireless manner

A cardholder uses his or her consumer device 702 to browse the offerings on the merchant's website, selects merchandise and/or services and then initiates a purchase transaction by providing payment card account information at the merchant's website checkout webpage (not shown) hosted by the merchant server 704. The payment account information typically includes a primary account number or “PAN”, an expiration date, a cardholder verification value or “CVC2” value, cardholder address information, and the like. The merchant website server 704 then transmits 705 a verify enrollment request (“VEReq”) message to a payment card processor system 706 which may include one or more computers, which may include a directory service server computer (not shown). The payment card account processor system 706 uses the account number in the VEReq message to transmit 707 that VEReq to an appropriate issuer Access Control Server (ACS) 708. Upon receipt of the VEReq, the ACS 708 verifies whether the cardholder's payment card account is enrolled in a 3-D Secure service (for example, the merchant ID may indicate enrollment in the 3-D Secure OBO merchants service) and if so the ACS 708 transmits 709 a positive verify enrollment response (“VERes”) message to the payment card processor system computer 706, which message includes the address of the ACS 708. The payment card processor system computer 706 then transmits 711 the positive VERes with the ACS address to the merchant server computer 704.

Continuing with the same example, the VERes message may indicate to the merchant server computer 704 that the cardholder's payment card is enrolled for the 3-D Secure OBO merchants service. The merchant server computer 704 then generates a payer authentication request message (“PAReq”) to authenticate the consumer (payer) for that particular online purchase, and transmits 713 the PAReq message directly to the ACS 208 (by using the ACS address) for cardholder authentication. If the ACS successfully authenticates the cardholder, the ACS next generates a positive payer authentication response (“PARes”) message which includes a UCAF. The positive PARes message is then transmitted 715 to the merchant server computer 704 and is also transmitted 717 to the payment card processor system 706. In some embodiments, the payment card processor system 706 includes a 3-D Secure OBO merchant service computer (not shown) for handling the PARes messages.

As explained herein, the positive PARes message includes fields containing the cardholder's PAN, an acquirer identifier, a merchant identifier, the date and/or time of the purchase transaction, the purchase transaction amount, a purchase transaction currency code, and the UCAF. In some embodiments, a transaction identifier (“XID”) is also included in the PARes message. In some implementations, the payment card processor system computer 706 stores the positive PARes messages (which includes the UCAF and the other transaction data) in a database (not shown), which may be a separate secure storage device. After receiving the positive PARes message, the merchant server 704 generates a purchase transaction authorization request (and in some implementations, the merchant server 704 simply ignores the UCAF when generating the purchase transaction authorization request.) The merchant server then transmits 719 the purchase transaction authorization request to an acquirer FI computer 710, which forwards 721 the purchase transaction authorization request to the payment card processor system computer 706 (which includes one or more computers and/or computer systems).

Once the payment card processor system computer 706 receives the purchase transaction authorization request, it utilizes the merchant ID and/or the acquirer ID to determine whether or not the merchant and/or the acquirer FI is enrolled for the 3-D Secure OBO merchants service. If a determination is made that the merchant and/or acquirer is enrolled, the payment card processor system computer 706 uses the data in the purchase transaction authorization request to check if, for this particular purchase transaction, 3-D Secure OBO merchants service processing occurred. In particular, data in the purchase transaction authorization request (which includes the PARes data) is compared to the information stored in the database (PARes data). The stored PARes data includes the time and date of the online or remote purchase transaction, and in some embodiments the payment card processor system computer 706 compares this PARes data to the time and date of receipt of the purchase transaction authorization request. If the result falls within a predetermined period of time then the payment card processor system computer 706 conducts further processing. In some embodiments, the time gap between the time and date data of the stored PARes must be equal to or less than the time gap or range that an issuer FI would use when deciding if the authorization request message was timely received. As explained earlier, this time period may be on the order of 1 second to 120 seconds.

In some embodiments, if a match occurs between the stored PARes information and the data contained in the purchase transaction authorization request (and if the time gap is equal to or within the predetermined time period) then the payment card processor system computer 706 injects the UCAF (which was stored when the PARes data was stored) into the purchase transaction authorization request to create an updated purchase transaction authorization request. The payment card processor system computer 706 then transmits 723 the updated purchase transaction authorization request to the issuer FI computer 712A (which was determined to be the correct issuer FI for that payment card account) for purchase transaction authorization processing. In this case, the issuer FI 712A recognizes that the cardholder has been authenticated using a 3-D Secure protocol, and proceeds to process the updated purchase transaction authorization request. The issuer FI 712A therefore determines whether or not the consumer's payment card account is in good standing and/or whether the cardholder can or cannot afford to pay for the purchase transaction (for example, if the cardholder has an adequate credit line available to cover the purchase price for the transaction). If all is in order, the issuer FI transmits 725 a positive purchase transaction authorization or “transaction approved” response to the payment card processor system computer 706 which is then routed or transmitted 727 through to the acquirer FI 710. In some implementations, the acquirer FI transmits 729 the transaction approved message to the merchant server 704, which in turn transmits 731 a message to the consumer device 702. In some cases, the transaction approved message may appear, for example, on a display screen of the consumer's device and may recite: “Thank you for your purchase.” Thus, the described 3-D Secure OBO merchants authentication process is agnostic with regard to issuer FIs. In addition, the 3-D Secure OBO merchants service benefits merchants and/or acquirer FIs because, after a cardholder is authenticated and the purchase transaction is authorized, liability for that purchase transaction shifts to the issuer FI regarding any fraud charges and any related chargebacks that may occur.

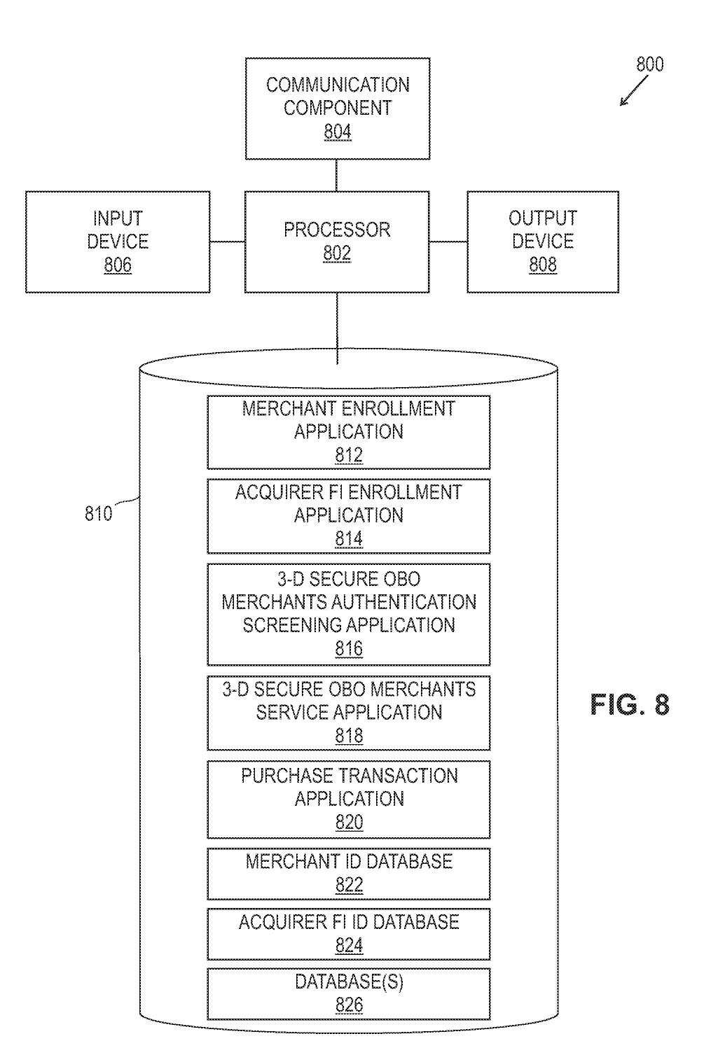

FIG. 8 is a block diagram of an embodiment of a payment card processor system computer 800 according to an embodiment. The payment card processor system computer 800 may be conventional in its hardware aspects but may be controlled by software to cause it to operate in accordance with aspects of the methods presented herein. In particular, the payment card processor system computer 800 may include a computer processor 802 operatively coupled to a communication component 804, an input device 806, an output device 808, and a storage device 810.

The computer processor 802 may constitute one or more conventional processors. Processor 802 operates to execute processor-executable steps, contained in program instructions described herein, so as to control the payment card processor system computer 800 to provide desired functionality.

Communication component 804 may be used to facilitate communication with, for example, other devices such as other computers (such as for communicating with acquirer FI computers, issuer FI computers, and the merchant OBO service computer over the internet). The communication component 804 may also, for example, have capabilities for engaging in data communications over conventional computer-to-computer data networks, and such data communications may be in digital form and/or in analog form.

Input device 806 may comprise one or more of any type of peripheral device typically used to input data into a computer. For example, the input device 806 may include a keyboard and a mouse and/or a touchpad or touchscreen that may be used, for example, by a systems engineer or other personnel authorized to, for example, perform payment network computer maintenance, upgrades or other tasks. The output device 808 may comprise, for example, a display and/or a printer or any other peripheral output device.

Storage device 810 may comprise any appropriate information storage device, including combinations of magnetic storage devices (e.g., magnetic tape and/or hard disk drives), optical storage devices such as CDs and/or DVDs, and/or semiconductor memory devices such as Random Access Memory (RAM) devices and Read Only Memory (ROM) devices, solid state drive (SSD) devices, and/or flash memory devices. Any one or more of the listed storage devices may be referred to as a “memory”, “storage”, a “storage medium”, or a “computer readable medium”. In addition, the storage devices are configurable and/or capable of storing instructions, code and/or data, including instructions configured to cause the processor 802 to execute one or more of the processes described herein. Thus, the storage device 810 stores one or more programs for controlling the processor 802, and the programs comprise program instructions that contain processor-executable process steps of the payment card processor system computer 800, including, in some cases, process steps that constitute processes provided in accordance with principles of the processes presented herein.

The programs may include a merchant enrollment application 812 that manages processes by which merchants register or enroll for the 3-D Secure OBO merchants authentication service, and an acquirer FI enrollment application 814 by which acquirer FIs may enroll their clients for the 3-D Secure OBO merchants authentication service, as explained herein. The merchants and/or acquirer FIs can enroll by utilizing, for example, a suitable web page hosted by the payment card processor system computer 800 to provide the required information. For example, the information gathered from a merchant may include the merchant's name and address and a merchant identifier, whereas the information obtained from an acquirer FI may include an acquirer identifier and identifiers concerning one or more clients (merchants).

The storage device 810 also stores a 3-D Secure OBO merchants screening application 816 that causes the processor 802 to screen received purchase transaction authorization requests for an indication that a particular purchase transaction may have underwent merchant OBO service processing. In some embodiments, a merchant ID and/or an acquirer FI ID of a received purchase transaction authorization request is compared to merchant and/or acquirer FI identifiers. If there is a match, then the payment card processor system computer 800 may then utilize, for example, a 3-D Secure OBO merchant service computer for further processing.

Referring again to FIG. 8, the storage device also includes a 3-D Secure OBO merchants authentication service application 818 for providing 3-D Secure OBO merchants service processing that may include, in accordance with the present disclosure, generating an updated purchase transaction authorization request message by injecting a UCAF into the received purchase transaction authorization request message. The 3-D Secure OBO merchants authentication service application is also configured to control the processor 802 to transmit the updated purchase transaction authorization request message to an issuer FI for purchase transaction authorization processing. In addition, the storage device 810 may include a purchase transaction application 820 for handling updated purchase transaction (which include a UCAF) that indicates 3-D Secure processing has occurred, in addition to handling purchase transaction authorization requests that have not been updated.

In addition, the storage device 810 may include a merchant ID database 822, an acquirer FI ID database 824, and one or more additional databases 826 that may include, for example, a PARes database (not shown). Such databases are maintained by the payment card processor system computer 800 on the storage device 810.

The application programs of the payment card processor system computer 800, as described above, may be combined in some embodiments, as convenient, into one, two or more application programs. Moreover, the storage device 810 may store other programs or applications, such as one or more operating systems, device drivers, database management software, web hosting software, and the like.

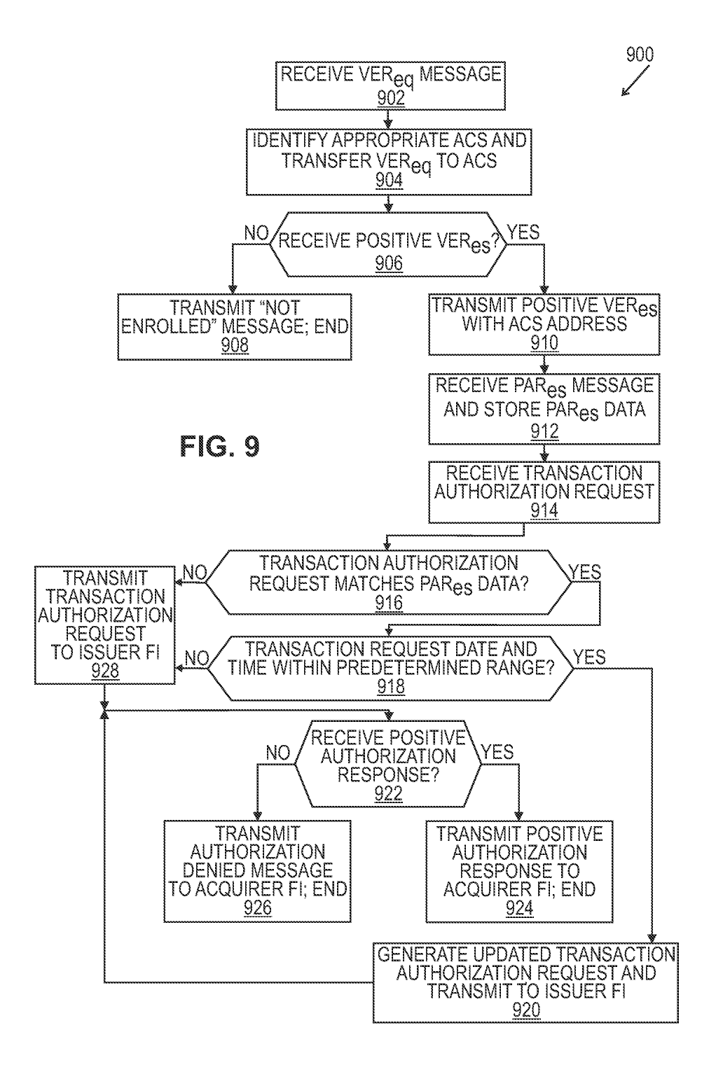

FIG. 9 is a flowchart 900 of a payment card processor system computer process in accordance with some embodiments. The payment card processor system computer receives 902 a verify enrollment request (VEReq) message and then identifies 904 an appropriate access control server (ACS) computer to use for further processing and transmits the VEReq message to that ACS. If a negative verification response (VERes) message in received 906, then the payment card processor system computer transmits a “not enrolled” message to the merchant server and the process ends. However, if a positive VERes message is received 906, then the payment card processor system computer transmits 910 that positive VERes message and the address of the ACS to the merchant server computer. Next, the payment card processor system computer receives 912 a payer authentication request (PAReq) message and stores the PAReq message data (which includes the date and time of the online or remote purchase transaction).

Next, the payment card processor system computer receives 914 a purchase transaction authorization request message, and compares the data contained in that request message to the stored PARes data. If there is a match in step 916 between the purchase transaction authorization request message data and stored PARes data, then the payment card processor system computer determines 918 whether or not the purchase transaction authorization request message data was received within a predetermined time period as compared to the date and time stored with the PARes data. If it is determined that the purchase transaction authorization request message data was received within a predetermined time period as compared to the data and time of the PARes message data, then the payment card processor system computer generates 920 an updated purchase transaction authorization message by injecting the UCAF (found in the stored PARes data) and transmits the updated purchase transaction authorization message to an issuer FI for authorization processing.

As explained above, the issuer FI recognizes that the cardholder has been authenticated using a 3-D authorization protocol, and then proceeds to process the updated purchase transaction authorization request accordingly. If the payment card processor system computer receives 922 a positive authorization response from the issuer FI, then the payment card processor system computer transmits 924 the positive authorization response to the acquirer FI. In this case, liability for that purchase transaction shifts to the issuer FI regarding any fraud charges and any related chargebacks that may occur, which is beneficial for the merchant and for the acquirer FI. But if a positive authorization response is not received, then the payment card processor system computer transmits 926 an “authorization denied” message to the acquirer FI, and the process ends.

However, if in step 916 the transaction authorization request does not match the stored PARes data, or if in step 918 the payment card processor system computer determines that the received purchase transaction authorization request time and date is not within a predetermined range of the stored PARes time and date, then the payment card processor system computer transmits 928 the original (not updated) purchase transaction authorization request to the appropriate issuer FI. In this case, the issuer FI recognizes that a 3-D Secure process was not carried out, and liability does not shift to the issuer FI for any fraud that may occur regarding the purchase transaction. If the payment card processor system computer receives 922 a positive authorization response from the issuer FI, then the payment card processor system computer transmits 924 the positive authorization response to the acquirer FI and the process ends. But if a negative response is received, then the payment card processor system computer transmits 926 an “authorization denied” message to the acquirer FI, and the process ends.

The 3-D Secure OBO merchants service provides enrolled merchants and/or acquirer FI's with a less complicated, secure online authentication process that reduces fraud and risk, and that is less technically complex and easier for merchants to implement and maintain. The 3-D Secure OBO merchants service is a cost efficient, reliable and secure system for processing purchase transactions that shifts the liability for any fraud and/or chargebacks with regard to an authorized purchase transaction to the issuer FI. The systems, apparatus and methods presented herein thus permit merchants and/or acquirer FIs to avoid the expense of purchasing, installing, implementing, and/or maintaining (or paying third parties to implement and manage), a merchant plug-in (MPI) application or other software that is necessary for implementing conventional 3-D Secure authentication protocols. In addition, consumers no longer have to enroll and establish a private code (such as a “SecureCode”), and are no longer presented with an authentication dialog in a separate authentication window each time the consumer wishes to purchase goods or services online (which is required by some conventional 3-D Secure processes). Thus, the consumer shopping experience is enhanced through use of the 3-D Secure OBO merchants authentication service without sacrificing the security of the transaction.

With regard to the flowcharts provided herein, it should be understood that the illustrated methods are not limited to the order shown. Rather, embodiments of the methods may be performed in any order that is practicable. For that matter, unless stated otherwise, any method disclosed herein may be performed in any order that is practicable. Notably, some embodiments may employ one or more portions of the methods illustrated herein without one or more other portions of the methods.

As used herein and in the appended claims, the term “payment card account” includes a credit card account or a deposit account that the account holder may access using a debit card. The term “payment card account number” or “financial account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, by a computer from an access control server (ACS) computer, a payer authentication response (PARes) message indicating enrollment in a 3-D Secure on-behalf-of (OBO) merchants authentication service;
storing, by the computer, the PARes message;
receiving, by the computer, a purchase transaction authorization request message;
determining that data of the purchase transaction authorization request message matches stored PARes message data;
injecting a UCAF of the PARes data into the received purchase transaction authorization request message to generate an updated transaction authorization request message; and
transmitting, by the computer to an issuer financial institution, the updated transaction request message for 3-D Secure purchase transaction authorization processing.

2. The method of claim 1, further comprising, prior to receiving the PARes message:
receiving, by the computer, a verify enrollment request (VEReq) message associated with an online purchase transaction;
transmitting the VEReq message to an appropriate ACS;
receiving, by the computer from the ACS, a verify enrollment response (VERes) message indicating enrollment in the 3-D secure OBO merchants service; and
transmitting, by the computer, the VERes message and an address of the ACS to a merchant server.

3. The method of claim 1, further comprising, subsequent to receiving the purchase transaction authorization request message:
determining, by the computer, that data of the purchase transaction authorization request message does not match stored PARes message data; and
transmitting, by the computer, a “no match” message to a payment network.

4. The method of claim 1, further comprising, prior to injecting the UCAF:
determining that a time and date of the of the purchase transaction authorization request is not within a predetermined time period of a time and date of the purchase transaction stored with the PARes message data; and
transmitting a “match but outside time period” message to a payment network.

5. The method of claim 4, wherein the predetermined time period is within a range of between about one second and about one hundred and twenty seconds.

6. The method of claim 1, wherein the computer is one of a payment card processor system computer or a 3-D Secure OBO merchants system computer.

7. An apparatus comprising:
a processor;
a communication component operably connected to the processor; and
a non-transitory storage device operably connected to the processor, wherein the non-transitory storage device includes instructions configured to instruct the processor to:
receive a payer authentication response (PARes) message indicating enrollment in a 3-D Secure on-behalf-of (OBO) merchants authentication service;
store the PARes message;
receive a purchase transaction authorization request message;
determine that data of the purchase transaction authorization request message matches stored PARes message data;
inject a UCAF of the PARes data into the received purchase transaction authorization request message to generate an updated transaction authorization request message; and
transmit the updated transaction request message to an issuer financial institution for 3-D Secure purchase transaction authorization processing.

8. The apparatus of claim 7, wherein the non-transitory storage device includes further instructions configured to instruct the processor to:
receive a verify enrollment request (VEReq) message associated with an online purchase transaction;
transmit the VEReq message to an appropriate ACS;
receive a verify enrollment response (VERes) message from the ACS indicating enrollment in the 3-D secure OBO merchants service; and
transmit the VERes message and an address of the ACS to a merchant server.

9. The apparatus of claim 7, wherein the non-transitory storage device stores further instructions, subsequent to the instructions for receiving the purchase transaction authorization request message, that are configured to cause the processor to:
determine that data of the purchase transaction authorization request message does not match stored PARes message data; and
transmit a “no match” message to a payment network.

10. The apparatus of claim 7, wherein the non-transitory storage device stores further instructions, prior to the instructions for injecting the UCAF, that are configured to cause the processor to:
determine that a time and date of the of the purchase transaction authorization request is not within a predetermined time period of a time and date of the purchase transaction stored with the PARes message data; and
transmit a “match but outside time period” message to a payment network.

11. A method, comprising:
receiving, by a payment network system computer from a merchant server computer, a verify enrollment request (VEReq) message associated with an online purchase transaction;
identifying, by the payment network system computer, an appropriate access control server (ACS) computer;
transmitting, to the ACS computer, the VEReq message;
receiving, by the payment network system computer from the ACS computer, a verify enrollment response (VERes) message indicating enrollment of a merchant in the 3-D secure OBO merchants service;
transmitting the positive VERes message with an address of the ACS computer to the merchant server computer;
receiving, by the payment network system computer from the ACS computer, a payer response (PARes) message; and
storing, by the payment network system computer, the PARes message with a time and date associated with a purchase transaction for use in future 3-D Secure on-behalf-of (OBO) merchants authentication service processing.

12. The method of claim 11, further comprising:
receiving, by the payment network system computer, a purchase transaction authorization request message;
determining that data of the purchase transaction authorization request message matches stored PARes message data;
injecting, by the payment network system computer, a UCAF of the stored PARes data into the received purchase transaction authorization request message to generate an updated transaction authorization request message; and
transmitting, by the payment network system computer to an issuer financial institution, the updated transaction request message for 3-D Secure purchase transaction authorization processing.

13. The method of claim 12, further comprising, subsequent to receiving the purchase transaction authorization request message:
determining, by the payment network system computer, that data of the purchase transaction authorization request message does not match stored PARes message data; and
transmitting, by the payment network system computer to an issuer financial institution, the transaction authorization request message for business-as-usual processing.

14. The method of claim 12, further comprising, prior to injecting the UCAF:
determining, by the payment network system computer, that a time and date of the purchase transaction authorization request is not within a predetermined time period of the time and date of the purchase transaction stored with the PARes message data; and
transmitting, by the payment network system computer to an issuer financial institution, the transaction authorization request message for business-as-usual processing.

15. An apparatus comprising:
a processor;
a communication component operably connected to the processor; and
a non-transitory storage device operably connected to the processor, wherein the non-transitory storage device includes instructions configured to instruct the processor to:
receive a verify enrollment request (VEReq) message associated with an online purchase transaction from a merchant server computer;
identify an appropriate access control server (ACS) computer;
transmit the VEReq message to the ACS computer;
receive a verify enrollment response (VERes) message from the ACS computer indicating enrollment of a merchant in the 3-D secure OBO merchants service;
transmit the positive VERes message with an address of the ACS computer to the merchant server computer;
receive a payer response (PARes) message from the ACS computer; and
store the PARes message with a time and date associated with a purchase transaction for use in future 3-D Secure on-behalf-of (OBO) merchants authentication service processing.

16. The apparatus of claim 15, wherein the non-transitory storage device includes further instructions configured to instruct the processor to:
receive a purchase transaction authorization request message;
determine that data of the purchase transaction authorization request message matches stored PARes message data;
inject a UCAF of the stored PARes data into the received purchase transaction authorization request message to generate an updated transaction authorization request message; and
transmit the updated transaction request message to an issuer financial institution for 3-D Secure purchase transaction authorization processing.

17. The apparatus of claim 16, wherein the non-transitory storage device stores further instructions, subsequent to the instructions for receiving the purchase transaction authorization request message, that are configured to cause the processor to:
determine that data of the purchase transaction authorization request message does not match stored PARes message data; and
transmit the transaction authorization request message to an issuer financial institution for business-as-usual processing.

18. The apparatus of claim 16, wherein the non-transitory storage device stores further instructions, prior to the instructions for injection the UCAF, that are configured to cause the processor to:
determine that a time and date of the purchase transaction authorization request is not within a predetermined time period of the time and date of the purchase transaction stored with the PARes message data; and
transmit the transaction authorization request message to an issuer financial institution for business-as-usual processing.
